(19) United States
(12) Patent Application Publication
(10) Pub. No.: US 2015/0234555 A1
(43) Pub. Date: Aug. 20, 2015

(54) DISPLAY DEVICE, SCREEN CONTROLLING METHOD AND NON-TRANSITORY COMPUTER READABLE RECORDING MEDIUM

(71) Applicant: Konica Minolta, Inc., Chiyoda-ku (JP)

(72) Inventor: Minako KOBAYASHI, Ikeda-shi (JP)

(73) Assignee: Konica Minolta, Inc., Chiyoda-ku (JP)

(21) Appl. No.: 14/619,214

(22) Filed: Feb. 11, 2015

(30) Foreign Application Priority Data
Feb. 18, 2014 (JP) 2014-028324

(51) Int. Cl. G06F 3/0483; G06F 3/0484

(52) U.S. Cl. CPC G06F 3/0483; G06F 3/04842

(57) ABSTRACT

A display device capable of displaying information corresponding to a setting state or an operation state of a function on an image processing device comprises: a display part; a browser configured to add a tab to each of multiple screens showing web contents and displaying the screen of the tab on the display part, and arranging the screen of the selected tab at the front of the screens of the other tabs; a managing part configured to manage if there is the tab showing the information on the screen among the tabs displayed by the browser; and a tab controlling part configured to delete the screen of another tab except for the screen of the tab when the tab managed as the one showing the information on the screen is not displayed at the front of the screen of the display part.

This application is based on the application No. 2014-028324 filed in Japan, the contents of which are hereby incorporated by reference.

### BACKGROUND OF THE INVENTION

1. Field of the Invention

The present invention relates to a display device, a screen controlling method and a non-transitory computer readable recording medium. The present invention more specifically relates to a technique for controlling a screen displayed by a browser.

2. Description of the Background Art

Some of conventional display systems have multi-window function with which more than one window may be displayed on a screen. On such system, a window displayed on a screen is grouped together with at least one of the other windows, and a group of the windows thereby grouped are processed in conjunction with each other. This known technique is introduced for example in Japanese Patent Application Laid-Open No. JP 2009-169545 A (hereafter, document 1). According to the known technique, users are allowed to give instructions to minimize or complete an application on all the multiple windows thereby grouped at once.

In recent years, browsers for displaying web contents have been installed on image processing devices such as MFPs (Multi-functional peripherals) including scan and/or print function. This type of image processing devices are capable of displaying an operational screens for users to use a variety of functions including scan and/or print function with web contents display function. The browser executes a program such as a script for bringing the variety of functions into operation, thereby bringing the variety of functions on the image processing device into operation to execute jobs, and displaying a job execution status. This type of browsers is capable of acquiring web contents from any servers connected to a network and displaying the acquired web contents on screens, as well as general browsers.

In recent years, this type of browsers have managed each of multiple screens on which web contents are displayed as a tab. Tab style browsers have become mainstream. The tab style browser arranges one of the screens corresponding to a tab selected by a user at the front of the screens corresponding to the other tabs and displays the screen by causing the user to select one of the multiple tabs. More than one tab may be displayed on the tab style browser. In such a case, only the screen corresponding to the tab arranged at the front may be viewed by the user. To be more specific, the rest of the screens of the other tabs hiding at the back of the screen of the front tab cannot be viewed by the user. The user may cause the image processing device to read a document with multiple pages with scan function, for example. In this case, the image processing device with the installed tab style browser is capable of displaying a new tab at the front so that the user is allowed to view external contents during execution of the scan job. The user is allowed to effectively use a waiting time.

However, the screen showing information such as the job execution status does not come up the front and may be hiding at the back. In such a case, the user may give an instruction to complete running of the browser by closing all the tabs without noticing the screen showing that the job is halfway through the execution, which is hiding at the back. With the instruction, the browser closes not only the screen corresponding to the tab at the front but also the screens of all the tabs at the back. As a result, the execution of the script shown by the screen of the tab at the back is terminated, and the job is canceled halfway through the execution.

In order to avoid the aforementioned problem, it is configured to close the screen of the tab at the front one by one when the user closes the tab, for example. When, however, more than one tab is displayed, the user is required to press a button, for example, repeatedly to close all tabs. This results in extreme reduction of operability, and is not preferable. The known technique disclosed in document 1 is not allowed to solve the above-described problem.

### SUMMARY OF THE INVENTION

The present invention is intended to solve the above conventional problems. Thus, the present invention is intended to provide a display device, a display controlling method and a non-transitory computer readable recording medium capable of preventing automatic termination of a process being executed due to a closing operation of a screen on which web contents are displayed.

First, the present invention is directed to a display device capable of displaying information corresponding to a setting state or an operation state of a function on an image processing device.

According to an aspect of the display device, the display device comprises: a display part on which a variety of images are displayed; a browser configured to add a tab to each of multiple screens showing web contents and displaying the screen of the tab on the display part, and arranging the screen of the selected tab at the front of the screens of the other tabs and displaying on the display part; a managing part configured to manage if there is the tab showing the information corresponding to the setting state or the operation state on the screen among the tabs displayed by the browser; and a tab controlling part configured to delete the screen of another tab except for the screen of the tab when the tab managed as the one showing the information corresponding to the setting state or the operation state on the screen is not displayed at the front of the screen of the display part in response to receiving an all tabs delete order as the browser is displaying more than one tab.

Second, the present invention is directed to an image controlling method for controlling a screen on which information corresponding to a setting state or an operation state of a function on an image processing device is shown.

According to an aspect of the image controlling method, the image controlling method comprises the steps of: (a) adding a tab to each of multiple screens showing web contents by a browser and displaying the screen of the tab on a predetermined display part, and arranging the screen of the selected tab at the front of the screens of the other tabs and displaying on the display part; (b) managing if there is the tab showing the information corresponding to the setting state or the operation state on the screen among the tabs displayed by the browser; and (c) deleting the screen of another tab except for the screen of the tab when the tab managed as the one showing the information corresponding to the setting state or the operation state on the screen is not displayed at the front of the screen of the display part in response to receiving an all tabs delete order as the browser is displaying more than one tab.

Third, the present invention is directed to a non-transitory computer readable recording medium on which a program is recorded. The program is executable on a display device including a display part on which a variety of images are displayed. The display device is capable of displaying information corresponding to a setting state or an operation state of a function on an image processing device.

According to an aspect of the non-transitory computer readable recording medium, the program causes the display device to execute the steps of: (a) adding a tab to each of multiple screens showing web contents by a browser and displaying the screen of the tab on the display part, and arranging the screen of the selected tab at the front of the screens of the other tabs and displaying on the display part; (b) managing if there is the tab showing the information corresponding to the setting state or the operation state on the screen among the tabs displayed by the browser; and (c) deleting the screen of another tab except for the screen of the tab when the tab managed as the one showing the information corresponding to the setting state or the operation state on the screen is not displayed at the front of the screen of the display part in response to receiving an all tabs delete order as the browser is displaying more than one tab.

### BRIEF DESCRIPTION OF THE DRAWINGS

FIG. 1 shows an exemplary configuration of a network system comprising an image processing device and a server;

FIG. 2 is a block diagram showing an exemplary hardware configuration and functional configuration of the image processing device;

FIGS. 3A and 3B show an example of screens displayed on a display unit by a browser;

FIGS. 4A and 4B show an example of the screens displayed on the display unit by the browser;

FIGS. 5A and 5B show an example of application management information;

FIGS. 6A and 6B show an example of tab management information;

FIG. 7 is a flow diagram explaining an exemplary process sequence of the main process executed by the browser;

FIG. 8 is a flow diagram explaining in detail an exemplary process sequence of an all tabs delete process;

FIG. 9 shows an example of the screen displaying a pop-up confirmation screen;

FIGS. 10A and 10B show an example of the screen displaying a pop-up list screen;

FIG. 11 shows an example of the modification of the display device which is not provided with the image processing device.

### DESCRIPTION OF THE PRESENT PREFERRED EMBODIMENTS

A preferred embodiment of the present invention is described in detail below with reference to figures. In the description given below, those elements which are shared in common among figures are represented by the same reference numerals, and these elements are not discussed repeatedly for the same description.

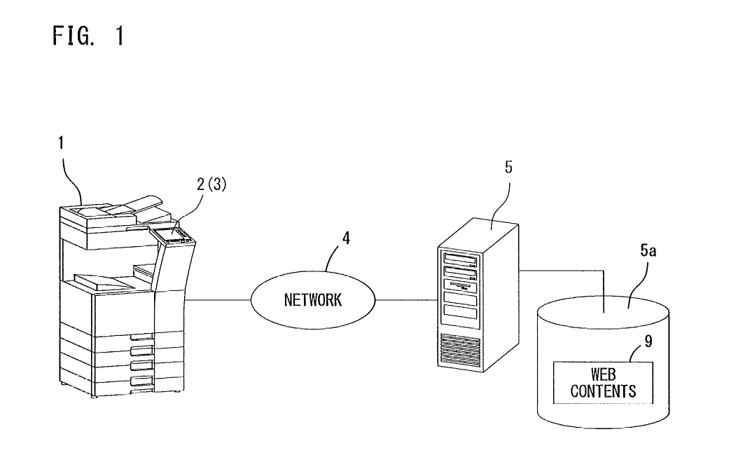

FIG. 1 shows an exemplary configuration of a network system comprising an image processing device 1 and a server 5. The image processing device 1 is formed from a device such as one of MFPs, for instance, and includes multiple functions such as scan function, print function copy function and fax function to execute jobs specified by users. An operational panel 2 is provided with front side of a device body of the image processing device 1 for the users to make a variety of inputs. The operational panel 2 serves as a display device 3 of the present invention. The operational panel 2 is capable of displaying screens to show a variety of information to the users and receiving inputs by the user through the screens. The operational panel 2 includes a function to display web contents by a browser. Thus, the operational panel 2 is also capable of displaying screens such as screens for the user to make inputs regarding settings as to jobs, screens for the user to give instructions to start job execution and screens showing that the job is halfway through the execution as web contents screens by the browser function. The operational panel 2 with the browser function is capable of displaying various types of web contents besides ones mentioned above. The image processing device 1 as described above is connected to the server 5 through a network 4 such as a LAN (Local Area Network) or an internet.

The server 5 serves as a web server includes a storage device 5a in which various types of web contents 9 are stored. The web contents 9 are screen information described in HTML (HyperText Markup Language), for instance. The web contents 9 are information containing, for example, a link to the other contents or a script (one kind of programs) executable on a browser. In response to receiving a contents acquiring request from a browser on the image processing device 1, the server 5 reads the web contents 9 in the storage device 5a, and sends the read web contents 9 to the image processing device 1 over the network 4. As a result, the image processing device 1 is allowed to display the web contents 9 received from the server 5 on the operational panel 2. In FIG. 1, only one server 5 is shown. The number of the server 5 connected to the network 4 is not always one. More than one server 5 is connected on a network environment including the internet in many cases. In such a case, the image processing device 1 is capable of acquiring the web contents 9 by accessing the more than one server 5, thereby displaying the web contents 9 on the operational panel 2.

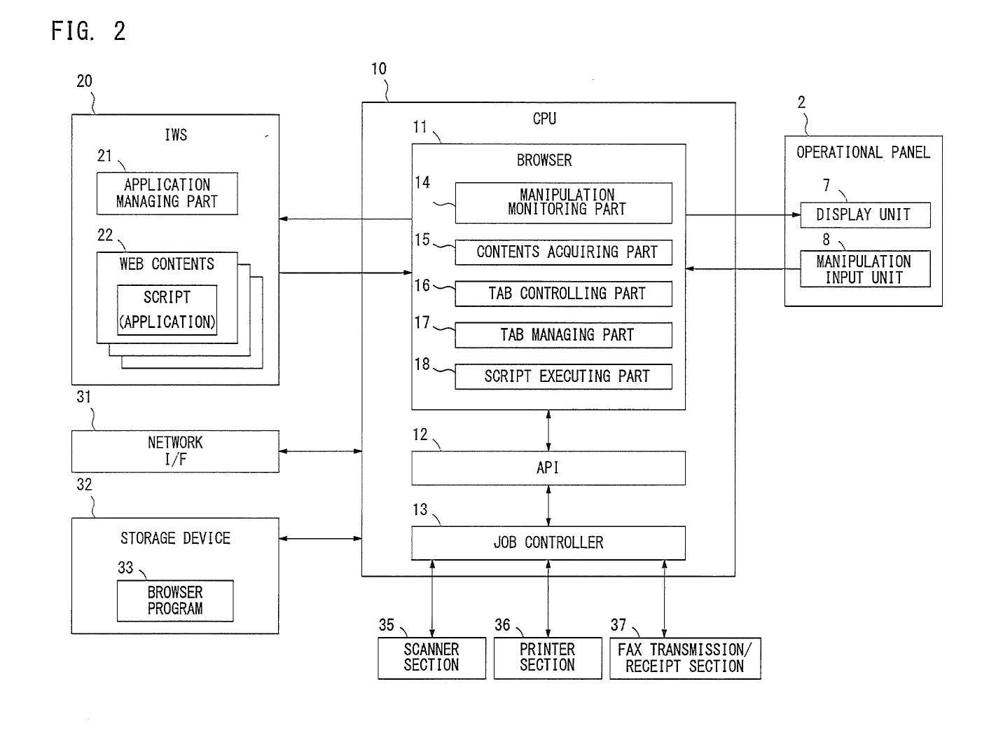

FIG. 2 is a block diagram showing an exemplary hardware configuration and functional configuration of the image processing device 1. The image processing device 1 includes a CPU 10, an internal web server (hereafter, IWS) 20, a network interface 31, a storage device 32, a scanner section 35, a printer section 36 and a fax transmission and receipt section 37, besides aforementioned operational panel 2.

The operational panel 2 includes a display unit 7 and a manipulation input unit 8 as illustrated in FIG. 2. The display unit 7 formed from a device such as a color liquid crystal display, for example, is capable of displaying various types of images on a brachymorphic display area. The manipulation input unit 8 formed with parts such as touch panel keys arranged on the screen of the display area of the display unit 7 and push-button keys arranged around the display area of the display unit 7, for example, receives inputs by the user.

The CPU 10 executes a variety of programs to control operations of each part. The IWS 20 serves as a web server in the image processing device 1. The IWS 20 outputs a screen to display on the display unit 7 of the operational panel 2, for instance, as web contents described in a language such as HTML. The network interface 31 connects the image processing device 1 to the network 4. The storage device 32 is formed from a nonvolatile storage device such as a hard disk drive (HDD), for instance. The storage device 32 stores therein in advance the variety of programs and data executed by the CPU 10. The storage device 32, for example, stores therein in advance a browser program 33. The storage device 32 stores therein in advance a variety of programs besides the browser program 33, such as an operating system which is not illustrated in FIG. 2.

The scanner section 35 reads a document and generates image data. The scanner section 35 reads the document at execution of a scan job or a copy job. The printer section 36 produces a printed output based on the received image data. The printer section 36 forms images on a sheet such as a printing sheet and outputs when producing the printed output in response to the print job or the copy job. The fax transmission and receipt section 37 sends and receives fax data over a telephone line which is not shown in FIG. 2.

The CPU 10 reads and executes the operating system not illustrated in FIG. 2 in the storage device 32 after the image processing device 1 is powered on, thereby serving as an application program interface (hereafter, API) 12 and a job controller 13. The API 12 servers as an interface between a various types of applications run on the CPU 10 and the job controller 13. The API 12 mediates transmission and receipt of data or commands to and from each other between the applications and the job controller 13. Thus, the application run on the CPU 10 is allowed to provide the job controller 13 with setting information and/or job execution instructions on a variety of jobs via the API 12.

The job controller 13 controls each operation of the scanner section 35, the printer section 36 and the fax transmission and receipt section 37. The job controller 13 transmits and receives the data and/or the command to and from the application run on the CPU 10 via the API 12, thereby changing settings on the respective sections, the scanner section 35, the printer section 36 and the fax transmission and receipt section 37. By bringing each section, the scanner section 35, the printer section 36 and the fax transmission and receipt section 37 into operation, the job controller 13 controls execution of the job specified by the user.

The CPU 10 serves as a browser 11 as one of the applications. It is assumed, for example, the CPU 10 detects a user instruction to startup the browser program 33 as the operating system is running. In this case, the CPU 10 reads and executes the browser program 33 in the storage device 32. The browser 11, the API 12 and the job controller 13 are then brought into operation at the same time on the CPU 10. The browser 11 is capable of acquiring the web contents from the IWS 20 and displaying on the display unit 7. Also, the browser 11 is capable of acquiring the web contents from the external server 5 via the network interface 31 and displaying on the display unit 7.

The IWS 20 is configured to provide the browser 11 with the information including a screen to use the function on the image processing device 1 as the web contents. The IWS 20 stores multiple web contents 22 corresponding to the respective functions such as the scan function and the print function. The web contents 22 is screen information described in the language such as HTML (HyperText Markup Language), for instance, as the same as the web contents 9 stored on the external server 5. The web contents 22 is information containing a link to the other contents and/or a script (one kind of programs) executable by the browser 11.

The IWS 20 includes an application managing part 21 The application managing part 21 manages the execution state of the script by the browser 11 or the operation state of each function such as the scan function. In response to reading the web contents 22 to use the scan function and executing the script contained in the web contents 22, for example, the browser 11 starts inputting and outputting the data or the command to and from the job controller 13 via the API 12. As a result, the scan function on the image processing device 1 is being in operation. In response to executing another script contained in the web contents 22 based on the user instruction, the browser 11 changes the setting value as to the scan function based on the user instruction and/or starts a reading operation of a document with the scan function. The application managing part 21 manages the startup state or operating state of each function on the image processing device 1 controlled by the browser 11 as described above.

The browser 11 reads the web contents 22 from the IWS 20 and displays the read web contents 22 on the display unit 7, thereby displaying the screen for the user to use the function such as the scan function and the print function on the image processing device 1 on the operational panel 2. The script contained in the web contents 22 is one kind of the application programs executed by the browser 11. The script of the present preferred embodiment passes the data or the command to and from the job controller 13 via the API 12, and brings the scanner section 35, the printer section 36 and the fax transmission and receipt section 37 into operation. The browser 11 displays the screen as to the variety of functions such as the scan function on the display unit 7 based on the web contents 22 stored by the IWS 20. A script execution instruction may be given in response to the user operation on the screen as the screen is being displayed by the browser 11, the browser 11 executes the script contained in the web contents 22 and starts working together with the job controller 13.

The browser 11 of the present preferred embodiment manages each of the multiple screens on which the web contents are displayed as a tab, and is a tab style browser arranges one of the screens corresponding to a tab selected by a user from among multiple tabs at the front and displays the screen.

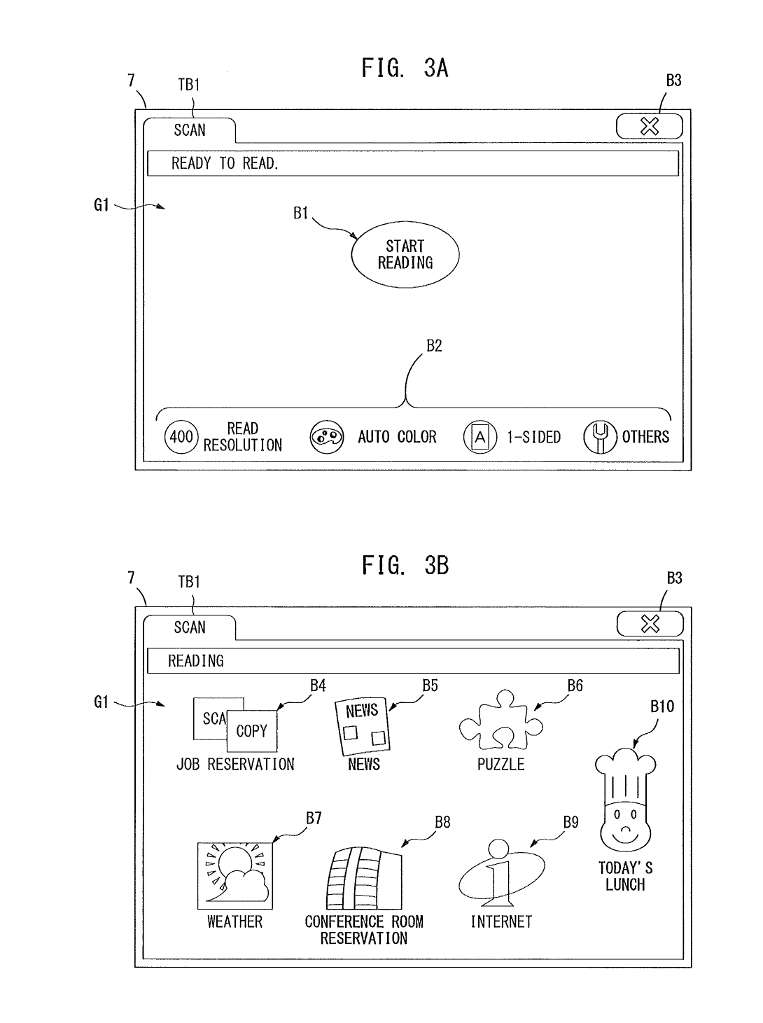

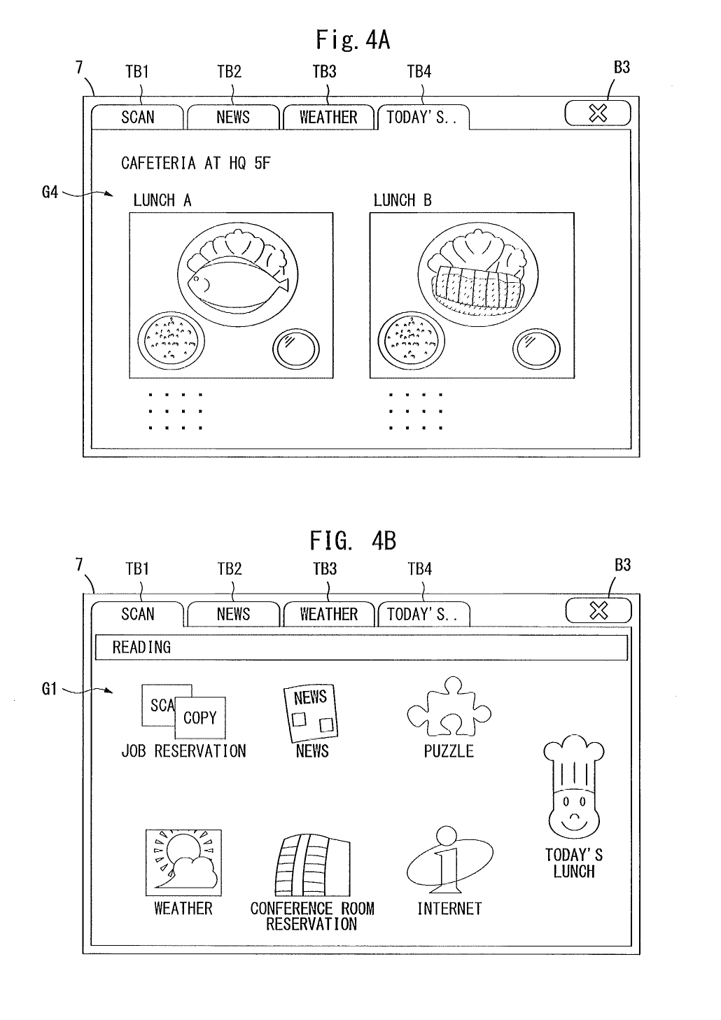

FIGS. 3A and 3B and FIGS. 4A and 4B show an example of the screens displayed on the display unit 7 by the browser 11. The CPU 10 executes the browser program 33 and the browser 11 is brought into operation. After being brought into operation, the browser 11 starts up at least one initial tab at first, and displays a screen specified in advance with the initial tab. The web contents 22 stored by the IWS 20 may be specified with the screen of the initial tab, for example. In this case, the browser 11 acquires the web contents 22 from the IWS 20 at its startup, and displays the screen corresponding to the web contents 22 acquired from the IWS 20 on the screen of the initial tab.

FIG. 3A shows an example when a tab TB1 is displayed on the display unit 7 as the initial tab in response to startup of the browser 11. A screen G1 of the tab TB1 is a screen for the user to use the scan function. A variety of information relating to the scan function and the operation buttons are displayed on the screen G1. In the example of FIG. 3A, a start button B1 and setting buttons B2 are displayed on the screen G1 of the tab TB1. When the user would like to give an instruction to start reading of the document, he or she presses the start button B1. When the user would like to configure a variety of settings on reading of the document, he or she presses one or more setting button B2. Information such as link information to switch the contents displayed on the screen G1 to the other contents or the script executed by the browser 11 is allocated to the start button B1 and the setting buttons B2. The user presses one or more setting button B2 so that the screen G1 of the tab TB1 is changed to a detail setting screen of the scan function, and he or she is allowed to configure the variety of settings on the scan function. Also, the user presses the start button B1, thereby giving the instruction to start reading of the document and making the image processing device 1 execute a scan job.

An all tabs delete button B3 is displayed at the upper-right corner of the screen G1. The user presses the all tabs delete button B3 to delete all tabs and complete running of the browser 11. Even when more than one tab is displayed by the browser 11, the all tabs delete button B3 is always displayed at the upper-right corner of the screen. Thus, the user is allowed to press the all tabs delete button B3 anytime during the running of the browser 11.

The start button B1 may be pressed by the user as the screen G1 illustrated in FIG. 3A is displayed. In such a case, the browser 11 sends a job execution instruction on the scan job to the job controller 13 via the API 12. The browser 11 then acquires the new web contents 22 based on the link information allocated with the start button B1, and changes the screen G1 of the tab TB1 to a screen as illustrated in FIG. 3B. FIG. 3B shows an example of the screen G1 showing that it is during the reading operation of the document with the scan function. Multiple link buttons B4 to B10 to browse another information during the reading operation of the document are displayed on the screen. When the user presses any one of the multiple link buttons B4 to B10, the browser 11 opens a new tab to display linked web contents on the new tab. Linked destination of each link button B4 to B10 may be the other web contents 22 stored by the IWS 20, or the web contents 9 stored on the external server 5.

FIG. 4A shows an example of a screen displayed when the user presses each of three link buttons B5, B7 and B10 during the reading operation of the document and three tabs TB2, TB3 and TB4 are displayed besides the tab TB1 that displays the screen G1 as to the scan function. For displaying the new tab, the browser 11 arranges the screen of the new tab at the front of the screens of the other tabs which have already been opened and displays on the display unit 7. In the example of FIG. 4A, a screen G4 of the tab TB4 corresponding to the link button B10 which is pressed at last by the user is displayed at the front. The screens or the other tabs TR1, TB2 and TB3 are displayed at the hack of the screen G4 of the tab TB4. Even as the multiple tabs TB1 to TB4 are being displayed, the all tabs delete button B3 is displayed at the upper-right corner of the screen as described above.

The user touches the tab TB1 as the screen of FIG. 4A is being displayed on the display unit 7, and he or she is allowed to select the screen G1 corresponding to the tab TB1 and display the tab TB1 at the front of the other tabs TB2 to TB4. FIG. 4B shows an example when the user selects the tab TB1 and the screen G1 as to the scan function is displayed at the front. As described above, as more than one tab is displayed by the browser 11, the user selects the tab TB1 of the screen G1 as to the scan function, thereby finding out the status of the scan job execution, for instance.

On the other hand, when another screen G4 is displayed at the front of the screen G1 as to the scan function, the screen G1 as to the scan function is hiding at the back of the screen G4 as illustrated in FIG. 4A. The user then is not allowed to see the status of the scan job execution, for instance. The user may press the all tabs delete button B3 without noticing the reading operation of the document by the scan function has not been complete yet. In such a case, when the all tabs delete button B3 is pressed by the user, the browser 11 detects an all tabs delete order. Also, when the user operation is not detected for more than a predetermined period of time, the browser 11 automatically detects the all tabs delete order after the predetermined period of time has elapsed.

As opening at least one tab and displaying the web contents on the screen, the browser 11 manages whether or not the screen of the tab is the screen to use the function on the image processing device 1. Furthermore, the browser 11 manages the operation state of the function corresponding to the screen when the screen is to use the function on the image processing device 1. To be more specific, the browser 11 acquires the web contents 22 to use each function on the image processing device 1 from the IWS 20, and displays the web contents 22 on the screen of any of the tabs. As displaying the web contents 22, the browser 11 acquires the information relating to the function on the image processing device 1 and/or the information relating to the operation state, and manages the use state or the operation state of the function on the image processing device 1 based on the acquired information.

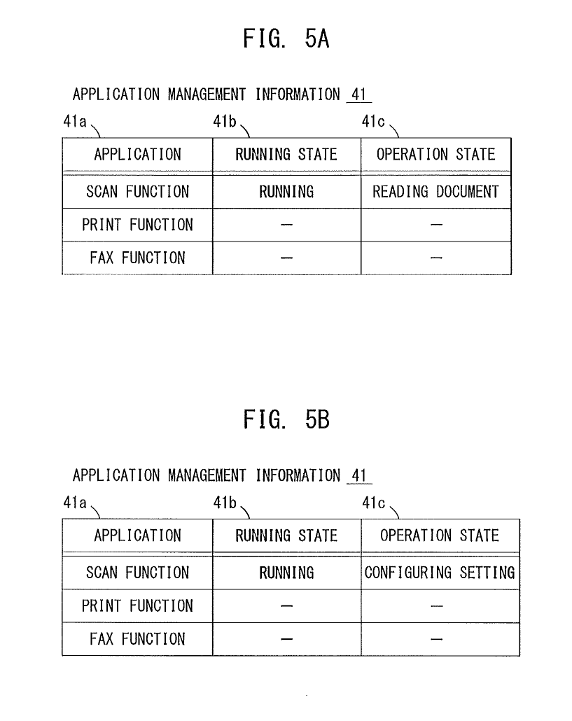

FIGS. 5A and 5B show an example of application management information 41 managed by the application managing part 21 of the IWS 20. The application managing part 21 associates information as to an application 41a, a running state 41b and an operation state 41c and the application management information 41 with each other and manages. Information relating to each function such as the scan function, the print function and the fax function on the image processing device 1 is registered in advance as the application 41a. Information showing whether or not each function registered in advance as the application 41a by the browser 11 is running is registered as the running state 41b. Information showing the operation state of each function run by the browser 11 is registered as the operation state 41c. More specifically, the application managing part 21 updates the information of the running state 41b and the operation state 41c in the application management information 41 in real-time based on the information such as the script execution state by the browser 11 contained in the web contents 22. As a result, the application managing part 21 is allowed to manage the running state and the operation state of each function on the image processing device 1 in real-time.

The application management information 41 of FIG. 5A shows that the scan function is running and the operation state of the scan function is during the reading operation of the document. The application management information 41 of FIG. 5B shows that the scan function is running and the operation state of the scan function is during the setting operation. As the operation state 41c of each function on the image processing device 1, the application management information 41 allows management of the operation state that the sections such as the scanner section 35 and the printer section 36 are actually operating and the setting state showing that the user is configuring the settings. The operation state and the setting state are managed distinctively from each other.

The browser 11 obtains the aforementioned application management information 41 from the IWS 20, and manages the tab added to the screen on which the web contents 22 acquired form the IWS 20 are displayed or the use state or the operation state of the function on the image processing device 1 corresponding to the screen of the tab. In response to detecting the all tabs delete order as more than one tab is being displayed, the browser 11 may not be displaying the screen of the tab which is managed as the one that is showing the information indicating each function on the image processing device 1 is being set or operated at the front of the screen on the display unit 7. In this case, the browser 11 is configured to delete all screens of the other tabs except for the screen of the tab which shows the information indicating each function on the image processing device 1 is being set or operated. The browser 11 as described above is explained in detail below.

As described above, the browser 11 of the present preferred embodiment serves as a manipulation monitoring part 14, a contents acquiring part 15, a tab controlling part 16, a tab managing part 17 and a script executing part 18 as shown in FIG. 2.

The manipulation monitoring part 14 monitors the input by the user through the operational panel 2 as the browser 11 is running. In response to obtaining manipulation input information by the user through the manipulation input unit 8, the manipulation monitoring part 14 outputs the obtained manipulation input information to each of the contents acquiring part 15, the tab controlling part 16, the tab managing part 17 and the script executing part 18. After detecting that the all tabs delete button B3 is pressed by the user, the manipulation monitoring part 14 generates the all tabs delete order and outputs the generated all tabs delete order to the tab controlling part 16. When the input by the user is not detected by the manipulation input unit 8 for more than a predetermined period of time, the manipulation monitoring part 14 generates the all tabs delete order and outputs the generated all tabs delete order to the tab controlling part 16.

The contents acquiring part 15 acquires the web contents from an address (a linked destination) designated by the user, and displays the acquired web contents on the screen of the tab already opened or the new tab. At the startup of the browser 11, for example, the contents acquiring part 15 acquires the web contents 22 from the address of the IWS 20 set in advance and displays the acquired web contents 22 on the screen of the initial tab.

The tab controlling part 16 displays the new tab by opening it, or deleting the already displayed tab by closing it. The tab controlling part 16 opens at least one initial tab at the startup of the browser 11, for example, and displays the web contents 22 acquired by the contents acquiring part 15 on the screen of the initial tab. When the operation to open the new tab is made by the user, or an order to open the new tab is given by the script executed by the script executing part 18, the tab controlling part 16 opens the new tab and displays the web contents acquired the contents acquiring part 15 on the screen of the new tab. When more than one tab is displayed, the tab controlling part 16 arranges and displays the screen of the tab at the front of the screens of the other tabs based on the selecting operation by the user. To be more specific, the tab controlling part 16 manages the screen to be displayed at the front of the screen on the display unit 7 distinctively from the screens to be hiding at the back of the screen at the front, and switches the screen to be displayed at the front based on the selecting operation by the user, for example.

In response to detecting the all tabs delete order received from the manipulation monitoring part 14, the tab controlling part 16 starts an all tabs delete process to close and delete the opened tab. Upon the start of the all tabs delete process, the tab controlling part 16 determines whether or not there is the screen showing that each function on the image processing device 1 is being set or being operated of the screens of the tabs being displayed. When there is the screen showing that each function on the image processing device 1 is being set or being operated, the tab controlling part 16 further determines if the screen showing that each function on the image processing device 1 is being set or being operated is displayed at the front of the screen on the display unit 7. If the screen is not displayed at the front of the screen on the display unit 7, the tab controlling part 16 leaves the screen which is showing that each function on the image processing device 1 is being set or being operated and not being displayed at the front, and closes the screens of the other tabs to delete from the screen.

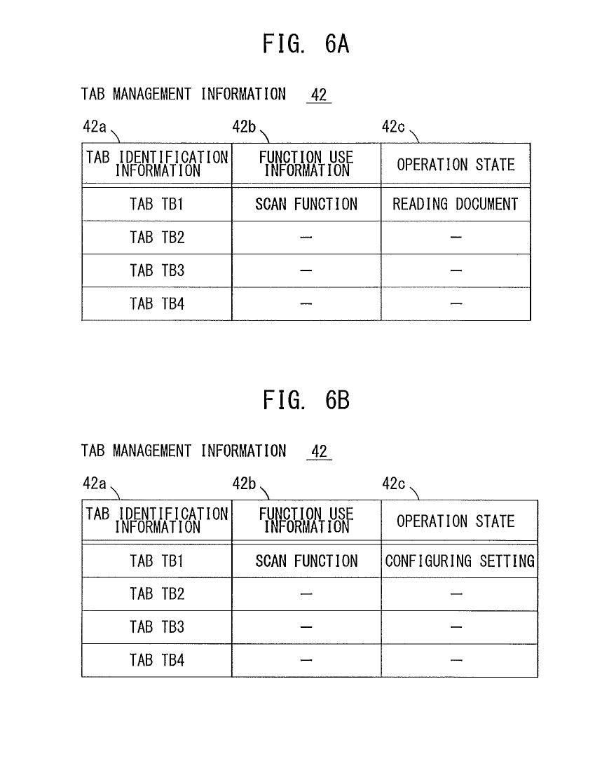

The tab managing part 17 manages whether or not the screen relating to the function on the image processing device 1 is being displayed of the screens of the respective tabs displayed by the tab controlling part 16. Also, the tab managing part 17 manages the operating state of the function when the screen relating to the function on the image processing device 1 is displayed. FIGS. 6A and 6B show an example of tab management information 42 managed by the tab managing part 17. The tab management information 42 includes tab identification information 42a, function use information 42b and an operating state 42c for each tab displayed by the tab controlling part 16. Every time the new tab is opened by the tab controlling part 16, the tab managing part 17 adds unique identification information to the new tab and registers with the tab identification information 42a. The tab managing part 17 obtains the tab management information 42 from the application managing part 21 of the IWS 20, and determines whether or not the screen to use the function on the image processing device 1 is displayed for each tab displayed by the tab controlling part 16. If there is any tab displaying the screen to use the function on the image processing device 1, the tab managing part 17 registers a name of the function and the operation state as the function use information 42b and the operating state 42c of the tab. The tab managing part 17 then repeatedly obtains the tab management information 42 at a regular basis, and updates the information registered as the function use information 42h and the operating state 42c in the tab management information 42 as required.

The tab management information 42 illustrated in each of FIGS. 6A and 6B shows when the four tabs TB1 to TB4 are displayed by the browser 11. The tab management information 42 of FIG. 6A shows that the scan function is running and the operation state of the scan function is during the reading operation of the document on the screen of the tab TB1. The tab management information 42 of FIG. 6B shows that the scan function is running and the operation state of the scan function is during the setting operation on the screen of the tab TB1. By referring the tab management information 42, it is allowed to find out in real-time whether or not each function on the image processing device 1 is running on the screen of each tab displayed by the tab controller 16.

In response to starting the all tabs delete process by detecting the all tabs delete order, the tab controller 16 obtains the tab management information 42 from the tab managing part 17, thereby determining if there is any tab displaying the screen showing that each function on the image processing device 1 is being set or in operation from among the tabs currently being displayed. Also, the tab controller 16 is allowed to determine whether or not the tab just determined is displayed at the front of the screen of the display unit 7.

The script executing part 18 executes the script contained in the web contents in response to receiving user operation. The script executing part 18 executes the script, thereby performing a variety of processes defined by the script. The script executing part 18, for instance, performs a process to issue and send an order to open a new tab to the tab controller 16 and/or a process to output the data or the command to the job controller 13 via the API 12.

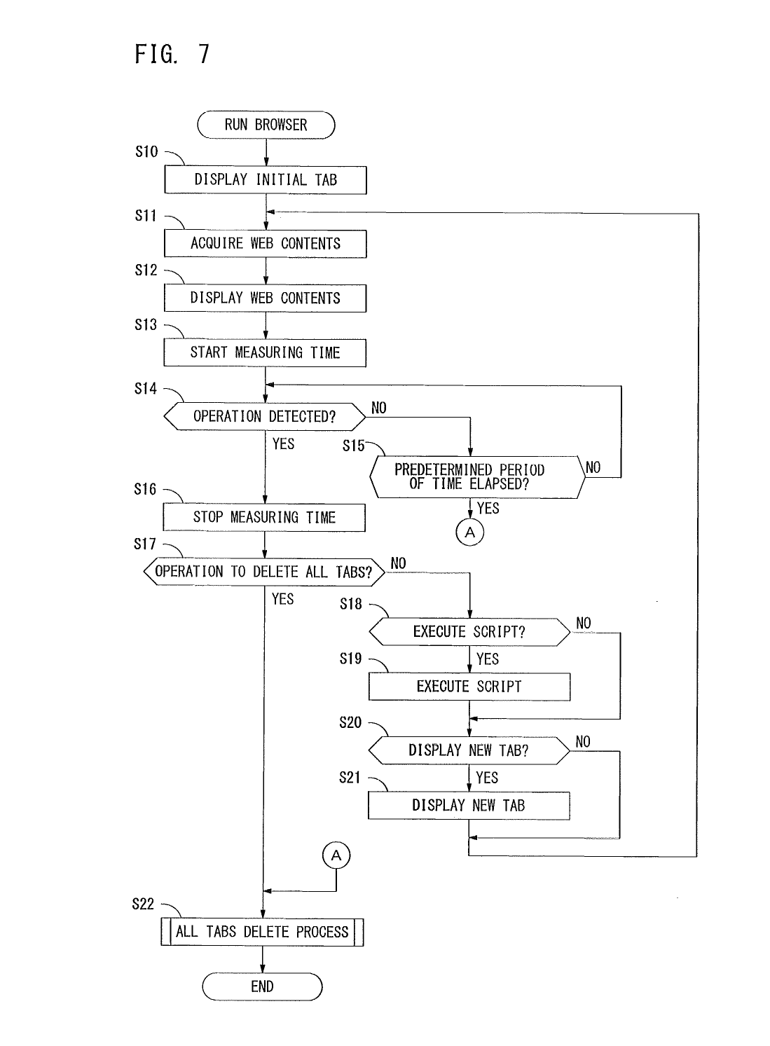

FIG. 7 is a flow diagram explaining in detail an exemplary process sequence of the process executed by the browser 11. In response to being started up on the CPU 10, the browser 11 brings the tab controller 16 into operation, and displays the initial tab on the display unit 7 (step S10). The browser 11 acquires the web contents 22 for the contents acquiring part 15 to display on the screen of the initial tab (step S11), and displays the screen of the initial tab based on the acquired web contents 22 (step S12). After displaying the screen of the initial tab, the browser 11 brings the manipulation monitoring part 14 into operation to start measuring a time elapsed since the screen has been displayed (step S13).

The manipulation monitoring part 14 determines whether or not the user operation has been detected (step S14). When no user operation has been detected (when a result of step S14 is NO), the manipulation monitoring part 14 determines if the predetermined period of time has elapsed since the start of measuring the time (step S15). When the predetermined period of time has not elapsed (when a result of step S15 is NO), the manipulation monitoring part 14 returns the process in step S14 to repeat the process in steps S14 and S15 until the user operation is detected or the predetermined period of time is elapsed without receiving the user operation. If the predetermined period of time is elapsed without receiving the user operation, the process performed by the browser 11 moves on to step S22.

When the user operation is detected before the predetermined period of time is elapsed (when a result of step S14 is YES), the manipulation monitoring part 14 stops measuring time and resets the measured time (step S16). The browser 11 determines whether or not the user operation is to delete the all tabs (step S17).

When the user operation is not to delete the all tabs (when a result of step S17 is NO), the browser 11 determines whether or not the user operation is to give the script execution instruction (step S18). If the script execution instruction is given, the browser 11 brings the script executing part 18 into operation to execute the script specified by the user (step S19). The browser 11 determines whether or not to display the new tab (step S20). When displaying the new tab, the browser 11 brings the tab controller 16 into operation to display the new tab on the display unit 7 (step S21). The process performed by the browser 11 returns to step S11 to perform the process to acquire the web contents to display on the tab or the web contents to update the screen of the tab already displayed and display (steps S11 and S12), and repeats the above-described process.

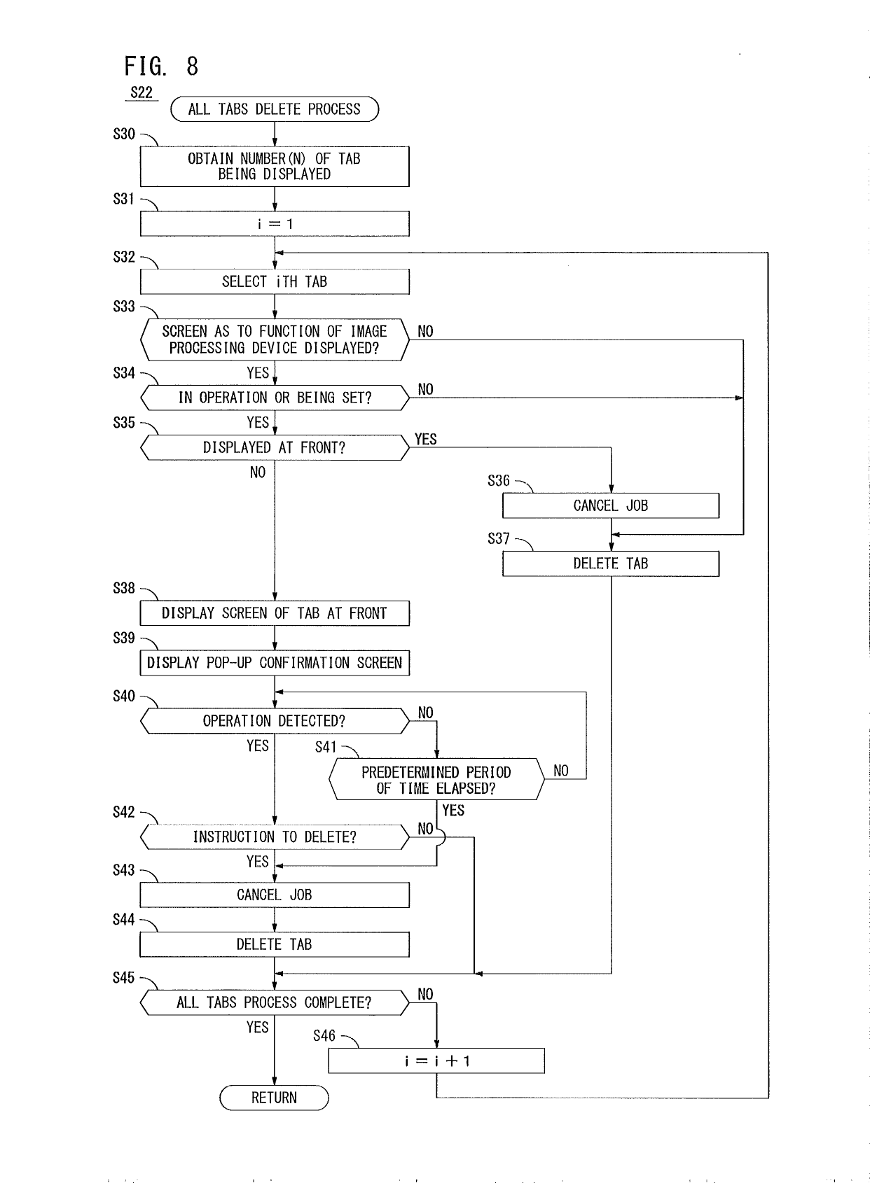

When the user operation is to delete all tabs (when a result of step S17 is YES), the browser 11 starts the all tabs delete process (step S22). FIG. 8 is a flow diagram explaining in detail an exemplary process sequence of the all tabs delete process (step S22). The all tabs delete process is mainly performed by the tab controller 16 of the browser 11. Upon start of the all tabs delete process, the tab controller 16 obtains the number (N) of the tab currently being displayed on the display unit 7 (step S30), and initializes a count value i to 1 (step S31). The tab controller 16 then selects ith tab (step S32).

The tab controller 16 obtains the tab management information 42 from the tab managing part 17, thereby determining if the selected ith tab is displaying the screen relating to any function on the image processing device 1 (step S33). When the ith tab is displaying the screen relating to the function on the image processing device 1 (when a result of step S33 is YES), the tab controller 16 determines whether or not the function is in operation or being set on the image processing device 1 (step S34). In step S32, it is determined whether or not the function on the image processing device 1 is in operation and the job is in execution, or the setting of the job is being configured by the user. If the function on the image processing device 1 is in operation or being set (when a result of step S34 is YES), the tab controller 16 determines whether or not the screen of the ith tab is displayed at the front of the screen of the display unit 7 (step S35).

When the screen of the ith tab is displayed at the front of the screen of the display unit 7 (when a result of step S35 is YES), the tab controller 16 cancels the job shown on the screen of the ith tab in the middle of the execution (step S36), and closes the ith tab to delete the screen (step S37). More specifically, the job execution status or the setting value still being configured may be shown on the screen of the ith tab. Even in such a case, when the screen is displayed at the front of the screen of the display unit 7, it is considered that the user intends to give the all tabs delete instruction after checking that the job execution is yet to be done. Hence, the tab controller 16 cancels the job and delete the ith tab from the screen.

The all tabs delete process may be performed because no user operation is detected for more than the predetermined period of time. In this case, the user has not given the all tabs delete instruction intentionally. If the job in execution is automatically canceled, this may cause an inconvenience. When the screen of the ith tab showing that the job is still in execution, for instance, is displayed at the front of the screen of the display unit 7 (when a result of step S35 is YES), the tab controller 16 may further determine if the all tabs delete order causing the all tabs delete process (step S22) is based on the all tabs delete instruction given by the user. The tab controller 16 may perform the process in steps S36 and 37 when the all tabs delete process is performed based on the all tabs delete instruction given by the user. To be more specific, if the all tabs delete process is performed because no user operation is detected for more than the predetermined period of time, the tab controller 16 does not perform the process in steps S36 and 37 and keeps displaying the screen of the ith tab as it is. By applying the process sequence, if the all tabs delete process is performed because no user operation is detected for more than the predetermined period of time, it is difficult to cause the inconvenience such as a situation that the job in execution is automatically canceled or that the setting value still being configured is discarded. The user may place the document with multiple pages on the image processing device 1 and give the job execution instruction. The given scan job is not canceled in the middle of the execution even if the user leaves the image processing device 1 for more than the predetermined period of time after giving the job execution instruction. As a result, the user is allowed to effectively use the time until the reading operation of the document with the multiple pages is complete.

After the determination in step S33, the ith tab may not be displaying the screen relating to the function on the image processing device 1 (when a result of step S33 is NO). In this case, the tab controller 16 moves on to the process in step S37. Moreover, after the determination in step S34, the function on the image processing device 1 shown on the screen of the ith tab may not be in operation or being set (when a result of step S34 is NO). Also in this case, the tab controller 16 moves on to the process in step S37. The tab controller 16 then closes the ith tab and deletes the screen (step S37).

If it is determined that the screen of the ith tab is not displayed at the front of the screen of the display unit 7 as a result of the determination in step S35 (when a result of step S35 is NO), the tab controller 16 displays the screen of the ith tab at the front of the screen of the display unit 7 (step S38). Thus, the screen showing that the function on the image processing device 1 is in operation or being set is displayed at the front of the screen of the display unit 7. The tab controller 16 may perform the process in step S38 as the screen of FIG. 4A is displayed on the display unit 7. The screen of the display unit 7 then automatically changes to the screen of FIG. 4B. With the change of the screen, the user is allowed to notice that there is still the job in execution, for instance. The tab controller 16 displays a pop-up screen to confirm the user whether or not to close the screen of the ith tab displayed at the front (step S39).

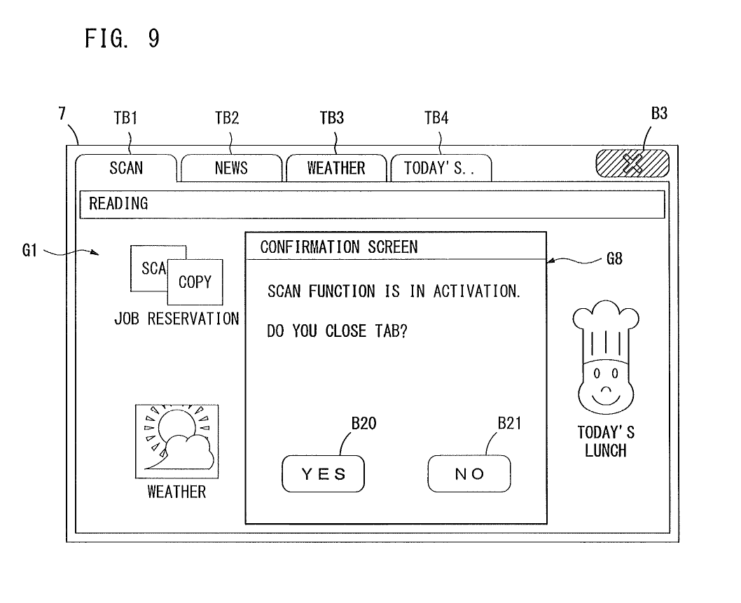

FIG. 9 shows an example of the screen displaying a pop-up confirmation screen G8. The tab controller 16 displays the pop-up confirmation screen G8 at the front of the screen G1 showing that the function on the image processing device 1 is in operation or being set as illustrated in FIG. 9. A message indicating that the function on the image processing device 1 is in operation is shown on the confirmation screen G8. Also, a button B20 which is pressed by the user when he or she gives an instruction to close the ith tab TB1 and a button B21 which is pressed by the user when he or she gives an instruction not to close the ith tab TB1 are shown on the confirmation screen G8. By displaying the pop-up confirmation screen G8, the user is allowed to be noticed more certainly to the job still in execution, for instance.

Referring back to FIG. 8, after displaying the pop-up confirmation screen G8, the tab controller 16 determines whether or not the user operation on the pop-up confirmation screen G8 is detected (step S40). If no user operation is detected (when a result of step S40 is NO), the tab controller 16 determines if the predetermined period of time has elapsed since the confirmation screen G8 has been displayed (step S41). The tab controller 16 repeats the determinations in step S40 and S41 until the user operation is detected or the predetermined period of time is elapsed. With the user operation on the pop-up confirmation screen G8 detected (when a result of step S40 is YES), the tab controller 16 determines whether or not the instruction to close the ith tab to delete the screen is given (step S42). With the instruction to delete the screen given by the user (when a result of step S42 is YES), the tab controller 16 cancels the job in the middle of the execution which is shown on the screen of the ith tab (step S43), and closes the ith tab to delete the screen (step S44). To be more specific, the tab controller 16 cancels the job and deletes the ith tab from the screen based on the delete instruction given by the user intentionally. When the instruction given by the user is not to delete the screen (when a result of step S42 is NO), the tab controller 16 does not perform the process in steps S43 and S44. Thus, the screen of the ith tab keeps showing as it is, and no inconvenience such as the job in execution is cancelled or the setting value still being configured is discarded is not caused.

The predetermined period of time may be elapsed without detecting any user operation on the confirmation screen G8 (when a result of step S41 is YES). In such a case, the tab controller 16 cancels the job in the middle of the execution which is shown on the screen of the ith tab (step S43) and closes the ith tab to delete the screen (step S44) as the same as when the delete instruction is given by the user. To be more specific, it is considered that the user has already left the image processing device 1 after he or she gave the all tabs delete instruction. Hence, the tab controller 16 deletes the ith tab if the operation on the confirmation screen G8 is not detected for more than the predetermined period of time.

The all tabs delete process (step S22) may be performed because no user operation is detected for more than the predetermined period of time. In this case, it is considered that the user has already left the image processing device 1 after he or she gave the job execution instruction. The user does not always give the instruction within the predetermined period of time even if the confirmation screen G8 is displayed. Especially when the user leaves the image processing device 1 soon after he or she gave the job execution instruction, the job which requires a relatively long time to complete execution is executed in many cases. Many users leave the image processing device 1 because they would like to effectively use the time until completion of execution of the job. The inconvenience may be caused if the job still in execution is automatically canceled after the predetermined period of time elapses without detecting the operation on the confirmation screen G8. When the predetermined period of time has elapsed without detecting the operation on the confirmation screen G8 (when a result of step S41 is YES), the tab controller 16 further determines if the all tabs delete order to cause the all tabs delete process (step S22) is based on the all tabs delete instruction given by the user. When the all tabs delete process is performed based on the all tabs delete instruction given by the user, the process in steps S43 and S44 may be performed. More specifically, when the all tabs delete process (step S22) is performed because the user instruction is not detected for more than the predetermined period of time, the process in steps S43 and S44 is not performed, and the screen of the ith tab is kept being displayed as it is. By applying such process sequence, aforementioned inconvenience is not caused.

As described above, the process with the ith tab is complete. The tab controller 16 then determines whether or not the process in the above-described steps S33 to S44 is performed with the all tabs currently being displayed (step S45). To be more specific, when the current count value i is the same as the number of the tabs N, the answer would be YES. If the count value i is less than the number of the tabs N, the answer would be NO. When the count value i is less than the number of the tabs N, the tab controller 16 increments the count value I (step S46), and repeats the process after step S32. When the count value i is the same as the number of the tabs N, the tab controller 16 completes the all tabs delete process (step S22).

In the above-described all tabs delete process (step S22), all tabs displayed on the display unit 7 by the browser 11 are not always deleted. The tab displaying the screen to use the function on the image processing device 1 is not immediately deleted in some cases. If the screen of the tab is showing that the function on the image processing device 1 is in operation or being set, and the screen is hiding at the back of the screens of the other tabs, the tab displaying the screen is not deleted immediately and kept being displayed. This may prevent from termination of the process performed on the screen of the tab.

When the function on the image processing device 1 is in operation, the tab kept being displayed may be closed after completion of the operation such as completion of the job execution. Then, after execution of all jobs is complete on the image processing device 1, all tabs kept being displayed are automatically closed and running of the browser 11 is complete.

The screen showing that the job is in execution may be hiding at the hack of the screens of the other tabs, for example. In such a case, in the above-described all tabs delete process (step S22), each screen showing that the job is in execution is displayed at the front one by one, and the confirmation screen G8 to confirm the user whether or not to close the tab is displayed. With the aforementioned process sequence, if more than one screen showing that the job is in execution is hiding at the back, the confirmation screen G8 is displayed for each screen. Thus, the user is required to select whether or not to close the tab and press the button every time the confirmation screen G8 is displayed. When more than one screen showing that the job is in execution is hiding at the back, for example, a pop-up screen showing all the more than one screen in a list form is displayed to reduce the number of the user operation to one in order to reduce the operation burden on the user.

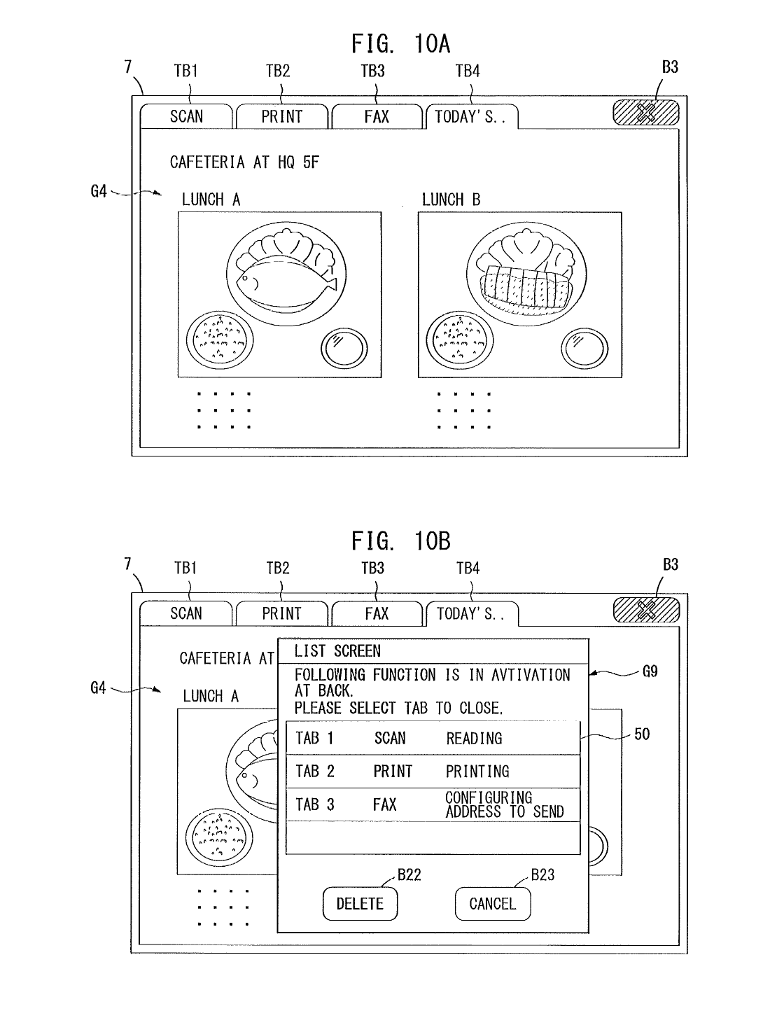

FIGS. 10A and 10B show an example of the screen displaying a pop-up list screen G9. FIG. 10A shows an example of the screen displayed at the start of the all tabs delete process (step S22). On the screen as illustrated in FIG. 10A, a screen G4 of a tab TB4 is displayed at the front of the screen of the display unit 7. The screen G4 is not the one to use the function on the image processing device 1. Three screens of the tabs TB1 to TB3 are hiding at the back of the screen G4 of the tab TB4. The screen of the TB1 is to use the scan function. The screen of the TB2 is to use the print function. The screen of the TB3 is to use the fax function. When those screens are hiding at the back of the screen G4 of the tab TB4 and the function is in operation or being set on each of the screens of the tabs TB1 to TB3, the tab controller 16, as shown in FIG. 10B, displays the pop-up list screen G9 on which the process in execution on the respective screens of each of the multiple tabs TB1 to TB3 is shown in the list form. A list 50 is shown on the list screen G9. Information as to the multiple tabs TB1 to TB3 which are hiding at the back of the screen G4 displayed at the front and which shows the corresponding function is in operation or being set is displayed in the list form in the list 50. The user is allowed to select the tab he or she decides to close from the list 50 and press a delete button B22. The user may press a cancel button B23 not to close all the tabs TB1 to TB3 shown in the list 50. Thus, the tab controller 16 is capable of not only closing only the tab selected by the user of the multiple tabs TB1 to TB3 but also keeping displaying all the tabs TB1 to TB3 without closing them. By making one operation on the list screen G9, the user is allowed to give an instruction whether or not to close each of the multiple tabs TB1 to TB3, resulting in improvement in operability,

As described above, the display device 3 provided with the image processing device 1 is capable of displaying the information corresponding to the setting state or the operation state of the function on the image processing device 1. The display device 3 as described above is configured to include the display unit 7, the browser 11, the tab managing part 17 and the tab controller 16. The various types of images are displayed on the display unit 7. The browser 11 adds the tab to each of the multiple screens on which the web contents are displayed and displays the screen on the display unit 7, and arranges the screen of the selected tab at the front of the screens of the other tabs and displays the screen of the tab on the display unit 7. The tab managing part 17 manages if there is any tab displaying the screen on which the information corresponding to the setting state or the operation state is shown of the tabs displayed by the browser 11. The tab controller 16 deletes the screens of the other tabs except for the screen of the tab displaying the screen on which the information corresponding to the setting state or the operation state is shown when the tab managing part 17 manages that the tab displaying the screen on which the information corresponding to the setting state or the operation state of the function on the image processing device 1 is shown is not displayed at the front of the screen of the display unit 7. It is assumed that there is the screen of the tab on which the function on the image processing device 1 is in operation or being set is shown, and which is not being displayed at the front of the screen of the display unit 7. In this case, with this configuration, even when the all tabs delete instruction is detected by the tab controller 16, the tab is not deleted. As a result, the function on the image processing device 1 which is in operation or being set is not canceled in the middle of the process. If the user gives the instruction to delete all tabs without noticing that the screen showing the function is in operation is hiding at the back, the image processing device 1 does not cancel the function in operation and keeps the operation state.

The display device 3 as described above further includes the manipulation input unit 8 to receive the user operation. The tab controller 16 detects the all tabs delete order based on the user operation received by the manipulation input unit 8. In response to detecting the all tabs delete order based on the user operation, the tab controller 16 deletes the screen of the tab displayed at the front of the screen of the display unit 7 when the screen of the tab managed as the one on which the information corresponding to the function on the image processing device 1 which is in operation or being set is shown is displayed at the front of the screen of the display unit 7. To be more specific, in such a case, it is considered that the user has confirmed that the function on the image processing device 1 is in operation or being set by viewing at the screen displayed at the front of the screen of the display unit 7, and he or she has given the all tabs delete instruction. Hence, the function in operation on the image processing device 1 is forced to terminate based on the intentional operation made by the user.

As described above, when the information indicating that the function on the image processing device is being set or in operation is shown on the screen of the tab displayed not at the front, the screen is not deleted, and the screens of the other tabs are deleted. This effectively prevents automatic termination of the process in execution due to the close operation of the screen of the tab.

### MODIFICATIONS

While the present preferred embodiment of the present invention has been described above, the present invention is not limited to the present preferred embodiment. Various modifications may be applied to the present invention.

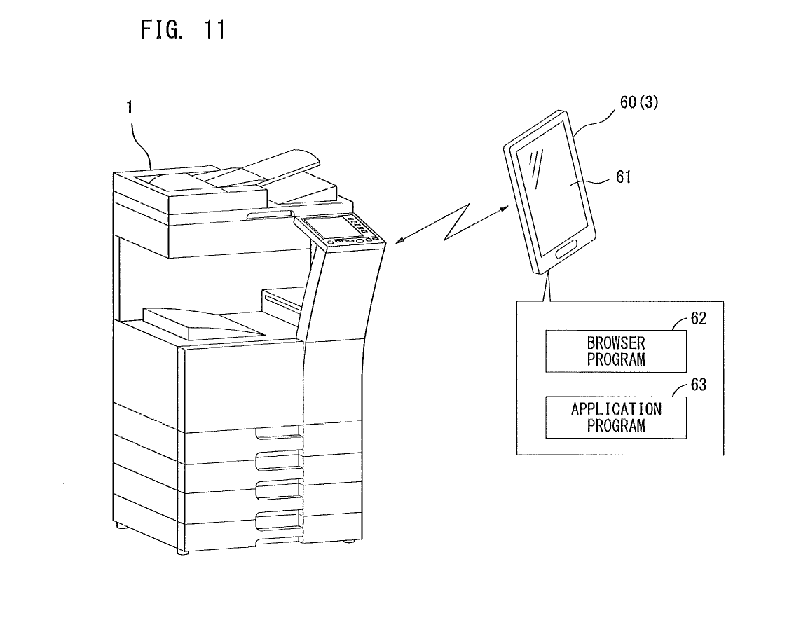

In the present preferred embodiment described above, the display device 3 is provided with the image processing device 1 as the operational panel 2. The display device 3, however, is not necessarily provided with the image processing device 1 as the operational panel 2. The display device 3 of the present invention may be a portable display device such as a smartphone or a tablet terminal, for instance, or may be implemented as a display device of a personal computer, for example. FIG. 11 shows an example of the modification. The display device 3 of FIG. 11 is formed from a terminal device 60 such as the smartphone or the tablet terminal which has a display unit 61. The display device 3 stores therein a browser program 62 installed in advance. The display device 3 executes the browser program 62, thereby serving as the browser 11, the manipulation monitoring part 14, the contents acquiring part 15, the tab controlling part 16, the tab managing part 17 and the script executing part 18 as described above. The browser program 62 is executed to cause the browser 11 to work together with the image processing device 1. With execution of the browser program 62 on the display device 3, communication with the image processing device 1 is established, and each aforementioned part is caused to work together with the image processing device 1. The same operation as described above may also be applied to such display device 3.

What is claimed is:

1. A display device capable of displaying information corresponding to a setting state or an operation state of a function on an image processing device, comprising:
a display part on which a variety of images are displayed;
a browser configured to add a tab to each of multiple screens showing web contents and displaying the screen of the tab on said display part, and arranging the screen of the selected tab at the front of the screens of the other tabs and displaying on said display part;
a managing part configured to manage if there is the tab showing the information corresponding to said setting state or said operation state on the screen among the tabs displayed by said browser; and
a tab controlling part configured to delete the screen of another tab except for the screen of the tab when the tab managed as the one showing the information corresponding to said setting state or said operation state on the screen is not displayed at the front of the screen of said display part in response to receiving an all tabs delete order as said browser is displaying more than one tab.

2. The display device according to claim 1, further comprising:
a manipulation input part configured to receive a user operation, wherein
said tab controlling part detects said all tabs delete order based on the user operation received by said manipulation input part.

3. The display device according to claim 2, wherein
said tab controlling part deletes the screen of the tab when the tab managed by said managing part as the one showing the information corresponding to said setting state or said operation state on the screen is displayed at the front of the screen of said display part in response to receiving said all tabs delete order.

4. The display device according to claim 1, further comprising:
a manipulation input part configured to receive a user operation; and
a manipulation monitoring part configured to send said all tabs delete order when the user operation is not detected by said manipulation input part for more than a predetermined period of time, wherein
said tab controlling part detects said all tabs delete order received from said manipulation monitoring part.

5. The display device according to claim 1, wherein
said tab controlling part, when deleting the screen of said another tab, displays the screen of the tab which is managed by said managing part as the one showing the information corresponding to said setting state or said operation state on the screen at the front of the screen of said display part, and displaying a confirmation screen which confirms the user whether or not to delete the screen of the tab on said display part.

6. The display device according to claim 5, wherein
said tab controlling part, when a delete instruction is input by the user as said confirmation screen is displayed on said display part, deletes the screen of the tab which is managed by said managing part as the one showing the information corresponding to said setting state or said operation state on the screen.

7. The display device according to claim 3, wherein
said tab controlling part, when deleting the screen of the tab which is managed by said managing part as the one showing the information corresponding to said setting state or said operation state on the screen, cancels the setting or the operation of the function on said image processing device managed by the screen of the tab.

8. The display device according to claim 5, wherein
said tab controlling part, when the predetermined period of time has elapsed without receiving any input of the instruction by the user as said confirmation screen is displayed on said display part, deletes the screen of the tab which is managed by said managing part as the one showing the information corresponding to said setting state or said operation state on the screen.

9. The display device according to claim 1, wherein
said tab controlling part, when any one of the multiple screens of the tabs which are managed by said managing part as the ones showing the information corresponding to said setting state or said operation state on the respective screens is displayed not at the front of the screen of said display part in response to receiving said all tabs delete order, displays a list screen containing information relating to the screens of said more than one lab on said display part, and deletes the screen of the tab selected by the user on said list screen.

10. The display device according to claim 1, wherein
said display device is implemented with said image processing device.

11. An image controlling method for controlling a screen on which information corresponding to a setting state or an operation state of a function on an image processing device is shown, the method comprising the steps of:
(a) adding a tab to each of multiple screens showing web contents by a browser and displaying the screen of the tab on a predetermined display part, and arranging the screen of the selected tab at the front of the screens of the other tabs and displaying on said display part;
(b) managing if there is the tab showing the information corresponding to said setting state or said operation state on the screen among the tabs displayed by said browser; and
(c) deleting the screen of another tab except for the screen of the tab when the tab managed as the one showing the information corresponding to said setting state or said operation state on the screen is not displayed at the front of the screen of said display part in response to receiving an all tabs delete order as said browser is displaying more than one tab.

12. A non-transitory computer readable medium on which a program is recorded, said program executed on a display device including a display part on which a variety of images are displayed, said display device capable of displaying information corresponding to a setting state or an operation state of a function on an image processing device, said program causing said display device to execute the steps of:
(a) adding a tab to each of multiple screens showing web contents by a browser and displaying the screen of the tab on said display part, and arranging the screen of the selected tab at the front of the screens of the other tabs and displaying on said display part;
(b) managing if there is the tab showing the information corresponding to said setting state or said operation state on the screen among the tabs displayed by said browser; and
(c) deleting the screen of another tab except for the screen of the tab when the tab managed as the one showing the information corresponding to said setting state or said operation state on the screen is not displayed at the front of the screen of said display part in response to receiving an all tabs delete order as said browser is displaying more than one tab.

13. The non-transitory computer readable recording medium according to claim 12, wherein
said display device further includes a manipulation input part configured to receive a user operation, and
in said step (c), said all tabs delete order is detected based on the user operation received by said manipulation input part.

14. The non-transitory computer readable recording medium according to claim 13, wherein
in said step (c), the screen of the tab is deleted when the tab managed in said step (b) as the one showing the information corresponding to said setting state or said operation state on the screen is displayed at the front of the screen of said display part in response to receiving said all tabs delete order.

15. The non-transitory computer readable recording medium according to claim 12, wherein
said display device further includes a manipulation input part configured to receive a user operation,
said program causes said display device to execute the step of: (d) sending said all tabs delete order when the user operation is not detected by said manipulation input part for more than a predetermined period of time, and
in said step (c), said all tabs delete order output in said step (d) is detected.

16. The non-transitory computer readable recording medium according to claim 12, wherein
in said step (c), when deleting the screen of said another tab, the screen of the tab which is managed in said step (b) as the one showing the information corresponding to said setting state or said operation state on the screen is displayed at the front of the screen of said display part, and a confirmation screen which confirms the user whether or not to delete the screen of the tab is displayed on said display part.

17. The non-transitory computer readable recording medium according to claim 16, wherein
in said step (c), when a delete instruction is input by the user as said confirmation screen is displayed on said display part, the screen of the tab which is managed in said step (b) as the one showing the information corresponding to said setting state or said operation state on the screen is deleted.

18. The non-transitory computer readable recording medium according to claim 14, wherein
in said step (c), when deleting the screen of the tab which is managed in said step (b) as the one showing the information corresponding to said setting state or said operation state on the screen, the setting or the operation of the function on said image processing device managed by the screen of the tab is canceled.

19. The non-transitory computer readable recording medium according to claim 16, wherein
in said step (c), when the predetermined period of time has elapsed without receiving any input of the instruction by the user as said confirmation screen is displayed on said display part, the screen of the tab which is managed in said step (b) as the one showing the information corresponding to said setting state or said operation state on the screen is deleted.

20. The non-transitory computer readable recording medium according to claim 12, wherein
in said step (c), when any one of the multiple screens of the tabs which are managed in said step (b) as the ones showing the information corresponding to said setting state or said operation state on the respective screens is displayed not at the front of the screen of said display part in response to receiving said all tabs delete order, a list screen containing information relating to the screens of said more than one tab is displayed on said display part, and the screen of the tab selected by the user on said list screen is deleted.
